(19) United States
(12) Patent Application Publication
(10) Pub. No.: US 2004/0175153 A1
(43) Pub. Date: Sep. 9, 2004

(54) Video and audio playing device

(76) Inventor: Hsiu-Ming Chu, Pingchen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/633,983

(22) Filed: Aug. 4, 2003

(30) Foreign Application Priority Data
Mar. 6, 2003 (TW) 092104864

(51) Int. Cl. H04N 5/781

(52) U.S. Cl. 386/96; 386/98; 386/125

(57) ABSTRACT

Disclosed is a video and audio playing device. When play data of each disk in a disk selection unit is not stored in a non-volatile memory unit, a control unit controls a reading unit to read the play data of each disk, so as to store to a non-volatile memory unit. When a user chooses the disk to play by selecting from a navigating key, the control unit collects the play data of the disk stored in the non-volatile memory unit, and also stores to a volatile memory unit. Afterwards, when media contents of the disks are played, the control unit collects the play data stored in the volatile memory unit, and then displays the play data on a display unit.

This application claims the benefit of Taiwan application Ser. No. 92104864, filed Mar. 6, 2003.

### BACKGROUND OF THE INVENTION

1. Field of the Invention

The invention relates in general to a video and audio playing device, and more particularly to a video and audio playing device having a non-volatile memory unit.

2. Description of the Related Art

In view of people's pursuit of sensual enjoyment in sight and hearing along with a time of highly developed technology, a video and audio playing device becomes indispensable in our daily lives. Particularly the video and audio playing device can provide drivers and passengers with entertainments and relaxation during a lone journey, when it is equipped on vehicles

Referring to FIG. 1, a circuit block diagram of a conventional video and audio playing device is shown. In the FIG. 1, a video and audio playing device 100 includes at least a control unit 102, which is coupled with a disk selection unit 104, a display unit 106, a volatile memory unit 108, an operation unit 110, a reading unit 112, and a playing unit 114. The video and audio playing device 100 can load several disks and play these disks, such as CDs, VCDs and DVDs. The following diagrams provide a simple explanation regarding an interaction relationship between each unit when the video and audio playing device 100 plays the disks.

FIG. 2 is a flow chart of a method for selecting and playing the disks, which are provided by the video and audio playing device as shown in FIG. 1. Referring to FIG. 1 and FIG. 2 simultaneously, firstly in a step 202 of the FIG. 2, power supply of the video and audio playing device 100 is switched on and several disks are loaded to the disk selection unit 104. The display unit 106 shows information about the number of the disks. And then proceeding to a step 204, a user can make use of the operation unit 110 to choose one of the disks to play. Naturally the user also can make use of the operation unit 110 to set playing orders of the disks, and also the playing orders of the disks will be stored to the volatile memory unit 108.

Next, proceeding to a step 206, the control unit 102 controls the reading unit 112 to read play code information of the disks, and to store the play code information to the volatile memory unit 108. The disks include media contents and the play code information. The media contents include several play items, and the play code information includes the number of the play items, the code and playing time of each play item. Besides, the control unit 102 can be a micro controller (MCU) or a digital signal processor (DSP) for example.

More specifically, the power supply of the video and audio playing device 100 should be in a power on state, so that the information stored in the volatile memory unit 108 can be reserved. Once the power supply of the video and audio playing device 100 is turned off, the information stored in the volatile memory unit 108 will be all gone. In addition, the volatile memory unit 108 can be a random access memory (RAM) for example.

Next, proceeding to a step 208, the control unit 102 controls the playing unit 114 to play the media contents of the disks, and to collect the play code information stored in the volatile memory unit 108, such as the code and playing time of each play item, so as to display on the display unit 106, and eventually the method comes to an end. Moreover, the display unit 106 can be a liquid crystal display panel (LCD panel) for example.

More specifically, when the video and audio playing device 100 plays the media contents of the next disk, the video and audio playing device 100 must read and store information of the next disk, so as to complete a preparation job before playing. Therefore, the method wastes a lot of time. Moreover, the volatile memory unit 108 only can store the information of the disks and set the playing orders of all disks when the power supply is turned on. Once the power supply of the video and audio playing device 100 is turned off, the information and settings stored in the volatile memory unit 108 will be all gone.

Besides, the video and audio playing device 100 only displays the number of the disks, the number of the play items of each disk, the code and playing time of each play item, etc. However, place orders of the disks, a title of each disk and a title of each play item, and the like, cannot be displayed. Therefore it is rather inconvenient that the user has to remember the place orders of the disks, the title of each disk and the title of each play item, etc.

### SUMMARY OF THE INVENTION

In view of the above-mentioned shortcomings, an objective of the present invention is to provide a video and audio playing device. The video and audio playing device configures a design of a non-volatile memory unit, which enables the video and audio playing device to promptly load play data of disks stored before from the non-volatile memory unit when every time the device is booted. Therefore, it is very convenient that a user can browse speedy, look up and choose a disk or play items to play.

According to an objective of the present invention, a video and audio playing device is provided including a control unit which is coupled to a disk selection unit, a reading unit, a non-volatile memory unit, a display unit, a navigating key, a volatile memory unit, and a playing unit. The disk selection unit is provided for loading several disks. The reading unit is used for reading the disks, and also the non-volatile memory unit is for storing play data of the disks. Besides, the display unit is for displaying the stored play data of the disks in the non-volatile memory unit. The navigating key is provided for browsing the play data of the disks that the display unit displays, and for choosing one of the disks to play. In addition, the volatile memory unit is used for storing the play data of the selected disks, and the playing unit is used for playing the media contents of the selected disks. More specifically, when the play data of the disks is not stored in the non-volatile memory unit, the control unit controls the reading unit to read the play data of the disks and then to store the play data of the disks to the non-volatile memory unit. When a disk is chosen, the control unit collects the play data of the chosen disk stored in the non-volatile memory unit, and then stores the play data of the disks to the volatile memory unit. When the media contents of the chosen disk are playing, the control unit collects the play data of the disk stored in the volatile memory unit, and then displays the play data on the display unit.

According to another objective of the present invention, a method for choosing and playing a disk is provided for a video and audio playing device, having a non-volatile memory unit and a volatile memory unit. Firstly, several disks are loaded. Next the play data of each disk is determined whether it is stored in the non-volatile memory unit. When the play data of each disk is not stored in the non-volatile memory unit, the play data of each disk is read and then the play data of each disk is stored to the non-volatile memory unit, so that the play data can be displayed. On the contrary, when the play data of each disk is stored in the non-volatile memory unit, the play data stored in the non-volatile memory unit is displayed. And then one of the disks is chosen to play. Next, the play data stored in the non-volatile memory unit is collected and stored to the volatile memory unit. Afterwards, the media contents of the disks are played and the play data stored in the volatile memory unit are collected, so as to display the play data. Eventually, the method comes to an end.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) shows a circuit block diagram of a conventional video and audio playing device.

FIG. 2 (prior art) is a flow chart of a method for selecting and playing disks, which are provided by the video and audio playing device as shown in FIG. 1.

FIG. 3 shows a circuit block diagram of a video and audio playing device according to a first preferred embodiment of the present invention.

FIG. 4 shows a circuit block diagram of a video and audio playing device according to a second preferred embodiment of the present invention.

FIG. 5 shows a flow chart of a method for choosing and playing the disk provided by the video and audio playing device according to the first preferred embodiment and the second preferred embodiment of the present invention.

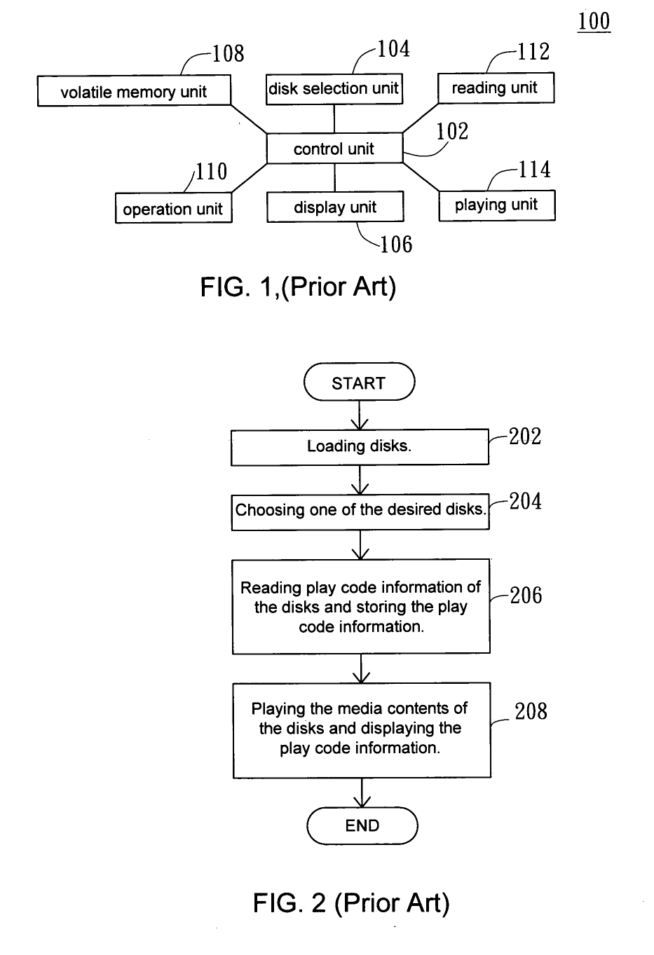

### DETAILED DESCRIPTION OF THE INVENTION

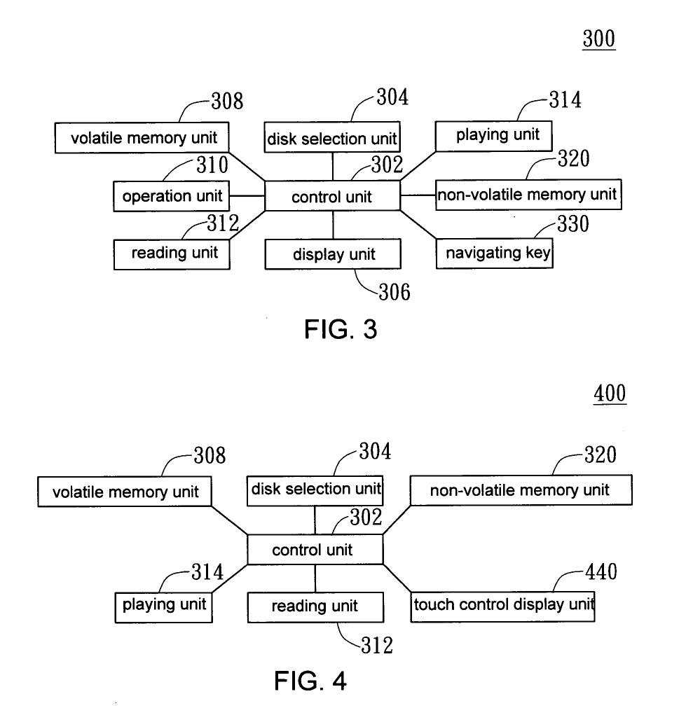

Referring to FIG. 3, a circuit block diagram of a video and audio playing device according to a first preferred embodiment of the present invention is shown. In the FIG. 3, the video and audio playing device 300 includes at least a control unit 302, which is coupled with a disk selection unit 304, a display unit 306, a volatile memory unit 308, an operation unit 310, a reading unit 312, a playing unit 314, a non-volatile memory unit 320, and a navigating key 330.

The disk selection unit 304 is provided for loading several disks, such as CDs, VCDs, and DVDs. The reading unit 312 is used for reading the disks, and also the non-volatile memory unit 320 serves to store play data of the disks when the disks are loaded for the first time. The present invention features that the non-volatile memory unit 320 still can permanently retain the stored play data of the disks even when power supply of the video and audio playing device 300 is switched off.

The display unit 306 is for displaying the stored play data of the disks in the non-volatile memory unit 320. The navigating key 330 is provided for browsing the play data of the disks that the display unit 306 displays, and to choose one of the disks to play. The navigating key 330 includes a cursor-moving key, which can control a cursor on a picture displayed by the display unit 306, and an instruction input key, which selects instructions from the picture displayed by the display unit 306. It is clear for people skilled in the art that the user can use the navigating key 330 or the operation unit 310 to set playing orders of all disks, and settings of the playing orders of all disks will be stored in the non-volatile memory unit 320. The volatile memory unit 308 functions to store the play data of the selected disks, and the playing unit 314 is used for playing the media contents of the selected disks. Moreover, when the power supply of the video and audio playing device 300 is switched off, information stored in the volatile memory unit 308 will be all gone.

When the control unit 302 determines that the play data of the disks is not stored in the non-volatile memory unit 320, the control unit 302 controls the reading unit 312 to read the play data of the disks and then to store the play data of the disks to the non-volatile memory unit 320. When a disk is chosen, the control unit 302 collects the play data of the chosen disk stored in the non-volatile memory unit 320, and then stores the play data of the disks to the volatile memory unit 308. When the media contents of the chosen disk are playing, the control unit 302 collects the play data of the disk stored in the volatile memory unit 308, and then displays the play data on the display unit 306.

Further, the disks include the media contents having several play items, and the play data having the titles of the disks, the titles of each play items, and the playing time of each play item.

FIG. 4 is a circuit block diagram showing a video and audio playing device according to a second preferred embodiment of the present invention. The difference between the second embodiment and the first embodiment is that a touch control display unit 440 integrates functions of the operation unit 310, the navigating key 330, and the display unit 306 of the FIG. 3. Apart from that, all other units in the second embodiment are the same as the first embodiment, so as to abbreviate here. Referring to FIG. 4, the touch control display unit 440 is coupled to the control unit 302. The touch control display unit 440 is used for displaying the play data of the disks stored in the non-volatile memory unit 320, and is also provided for browsing the play data of the disks and for choosing one of the disks to play. Besides, the touch control display unit 440 includes a cursor-moving key and an instruction input key. Certainly the user can use the touch control display unit 440 to set playing orders of all disks, and settings of the playing orders of the all disks will be stored to the non-volatile memory unit 320.

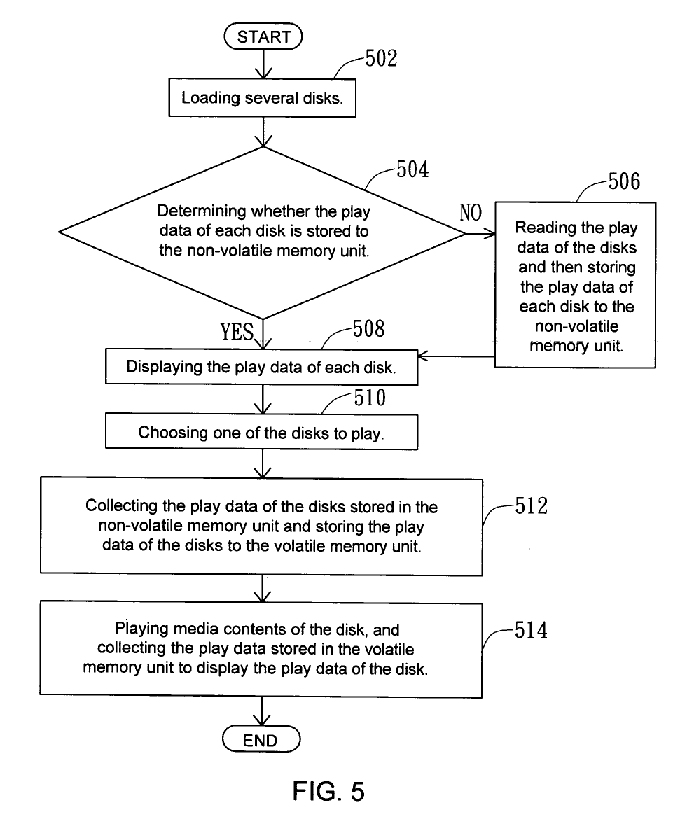

Referring to FIG. 5, it shows a flow chart of a method for choosing and playing the disk provided by the video and audio playing device 300 or 400 according to the first preferred embodiment or the second preferred embodiment of the present invention. Referring to the FIG. 3 and the FIG. 4 simultaneously, firstly a user turns on the video and audio playing device 300 or 400 and loads several disks to the disk selection unit 304 in a step 502 of the FIG. 5. Next, preceding to a step 504, the control unit 302 determines whether the play data of each disk is stored to the non-volatile memory unit 320. On one hand, when the play data of each disk is not stored in the non-volatile memory unit 320, go to a step 506 that the control unit 302 controls the reading unit 312 to read the play data of the disks and then to store the play data of each disk to the non-volatile memory unit 320. Next, proceed to a step 508 that the control unit 302 controls the display unit 306 or the touch control display unit 440 to display the play data stored in the non-volatile memory unit 320. On the other hand, when the play data of the disk is stored in the non-volatile memory unit 320, go to execute the step 508 directly that the control unit 302 controls the display unit 306 or the touch control display unit 440 displays the play data stored in the non-volatile memory unit 320. Moreover, the display unit 306 or the touch control display unit 440 also can display place orders of all the disks.

Next, proceeding to a step 510, the user browses the play data of each disk displayed by the display unit 306 or the touch control display unit 440, and uses the navigating key 330 or the touch control display unit 440 to choose one of the disks to play. Subsequently, proceeding to a step 512, the control unit 302 collects the play data stored in the non-volatile memory unit 320 and then stores to the volatile memory unit 308. Successively, proceeding to a step 514, the control unit 302 controls the playing unit 314 to play the media contents of the disks, and to collect the play data stored in the volatile memory unit 308, so as to display on the display unit 306 or the touch control display unit 440, and then the method ends.

Therefore, when the video and audio playing device plays another one of the media contents of the disks, since the non-volatile memory unit has stored the play data of the disks, the video and audio playing device does not need to execute the reading and storing actions of the play data of another disk again. Accordingly, the method is truly time-saving.

In addition, the design of configuring the non-volatile memory unit in the video and audio playing device can have the video and audio playing device display the stored play data of the non-volatile memory unit promptly after the player device is turned on every time, so as to provide for the user to browse speedy, look up and choose the disk or the play items. Therefore, it is very convenient. Further, the video and audio playing device of the present invention also can display the place orders, the titles of each disk, and the tile of each play item and the like, so that the user can obtain all the information at a glance and can get rid of trouble about remembering the information.

While the invention has been described by way of example and in terms of the preferred embodiments, it is to be understood that the invention is not limited thereto. The control unit can be a micro controller (MCU), or a digital signal processor (DSP) for example. The volatile memory unit can be a random access memory (RAM) for example. The non-volatile memory unit can be an erasable and programmable read only memory (EPROM), an EEPROM, a mask ROM, and a flash ROM for example. The display unit can be a liquid crystal display panel (LCD panel) for example, and the touch control display unit can be a LCD touch control display unit for example.

The video and audio playing device as above disclosed embodiments configures the design of the non-volatile memory unit, which can have the video and audio playing device display the stored play data of the non-volatile memory unit promptly after the video and audio playing device is turned on every time. Therefore, it is very convenient for the user to browse speedy, look up and choose the disk or the play items to play.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video and audio playing device, comprising at least:
a disk selection unit, for loading a plurality of disks;
a reading unit, for reading the disks;
a non-volatile memory unit, for storing a play data of the disks;
a display unit, for displaying the play data of the disks stored in the non-volatile memory unit;
a navigating key, for browsing the play data of the disks displayed on the display unit, and for choosing one of the disks to play; and
a control unit, which is coupled to the disk selection unit, the reading unit, the non-volatile memory unit, the display unit, and the navigating key, wherein while the play data is not stored in the non-volatile memory unit, the control unit controls the reading unit to read the play data, and also to store the play data to the non-volatile memory unit.

2. The device according to claim 1, wherein the video and audio playing device also comprises:
a volatile memory unit, which is coupled to the control unit, for storing the play data of the selected disk, wherein when the disk is selected, the control unit collects the play data stored in the non-volatile memory unit, and also stores the play data to the volatile memory unit; and
a playing unit, which is coupled with the control unit, for playing media contents of the disks, wherein when the media contents are playing, the control unit collects the play data of the disk stored in the volatile memory unit, and displays the play data on the display unit.

3. The device according to claim 2, wherein the volatile memory unit comprises a random access memory (RAM).

4. The device according to claim 2, wherein the media contents of the disk comprises a plurality of play items, and wherein the play data comprises at least a title of the disk and titles of each play item.

5. The device according to claim 1, wherein the non-volatile memory unit comprises a flash read only memory (flash ROM).

6. The device according to claim 1, wherein the display unit comprises a liquid crystal display panel (LCD panel).

7. The device according to claim 1, wherein the navigating key comprises a cursor-moving key and an instruction input key.

8. A video and audio playing device, comprising at least:
a disk selection unit, for loading a plurality of disks;
a reading unit, for reading the disks;
a non-volatile memory unit, for storing play data of the disks;
a touch control display unit, for displaying the play data of the disks stored in the non-volatile memory unit, and also for browsing the play data of the disks and for choosing one of the disks to play; and
a control unit, which is coupled to the disk selection unit, the reading unit, the non-volatile memory unit, and the touch control display unit, wherein while the play data of the disks is not stored in the non-volatile memory unit, the control unit controls the reading unit to read the play data of the disks, and also to store the play data of the disks to the non-volatile memory unit.

9. The device according to claim 8, wherein the video and audio playing device also comprises:
a volatile memory unit, which is coupled to the control unit, for storing the play data of the selected disk, wherein when the disk is selected, the control unit collects the play data of the disk stored in the non-volatile memory, and also stores the play data of the disk to the volatile memory unit; and
a playing unit, which is coupled with the control unit, for playing media contents of the disks, wherein when the media contents are playing, the control unit collects the play data of the disk stored in the volatile memory unit, and displays the play data of the disk on the touch control display unit.

10. The device according to claim 9, wherein the volatile memory unit comprises a random-access memory (RAM).

11. The device according to claim 9, wherein the media contents of the disk comprises a plurality of play items, wherein the play data comprises at least a title of the disk and titles of each play item.

12. The device according to claim 8, wherein the non-volatile memory comprises a flash read only memory (flash ROM).

13. The device according to claim 8, wherein the touch control display unit comprises a liquid crystal display panel (LCD panel).

14. The device according to claim 8, wherein the touch control display unit comprises a cursor-moving key and an instruction input key.

15. A method of choosing and playing a disk for a video and audio playing device, wherein the video and audio playing device comprises a non-volatile memory unit, wherein the method comprises at least:
loading a plurality of disks;
determining whether the play data of each of the disks is stored to the non-volatile memory unit;
wherein when the play data of each of the disks is not stored in the non-volatile memory unit, the play data of each of the disks is read and then the play data of each of the disks is stored to the non-volatile memory unit, so as to display the play data; wherein when the play data of each of the disks is stored in the non-volatile memory unit, the play data stored in the non-volatile memory unit is displayed; and
choosing one of the disks to play.

16. The method according to claim 15, wherein the method after a step of choosing one the disks further comprises:
collecting the play data of the disk stored in the non-volatile memory unit and also storing the play data of the disk to a volatile memory unit of the video and audio playing device; and
playing the media contents of the disks and collecting the play data of the disk stored in the volatile memory unit, so as to display the play data.

17. The method according to claim 16, wherein a step of storing the play data of the disk to the volatile memory unit of the video and audio layer device comprises storing the play data of the disk to a random access memory (RAM).

18. The method according to claim 16, wherein the media contents of the disk comprises a plurality of play items, wherein the play data comprises at least a title of the disk and titles of each play item.

19. The method according to claim 15, wherein the non-volatile memory comprises a flash read only memory (flash ROM).
